(19) United States
(12) Patent Application Publication
(10) Pub. No.: US 2004/0218512 A1
(43) Pub. Date: Nov. 4, 2004

(54) Recording medium apparatus

(76) Inventors: Atsushi Nishio, Ibaraki-Ken (JP); Takashi Kawasaki, Ibaraki-Ken (JP); Satoru Karahashi, Ibaraki-Ken (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/660,767

(22) Filed: Sep. 12, 2003

(30) Foreign Application Priority Data
Sep. 24, 2002 (JP) P2002-277825
Sep. 24, 2002 (JP) P2002-277826

(51) Int. Cl. G11B 17/00

(52) U.S. Cl. 369/290.1; 720/620

(57) ABSTRACT

A recording medium apparatus includes a base plate formed with a stop portion, a holder being slidable on the base plate while holding a recording medium inserted in the holder, and a reversing spring, of which pressing direction changes in accordance with a position of the holder, a first end of the reversing spring being locked on the base plate and a second end of the reversing spring being locked on the holder. The reversing spring has an arc portion between the first and the second ends, the circular portion extends in a plane surface. The stop portion is locked in the holder so as to fix the holder in a predetermined position.

### BACKGROUND OF THE INVENTION

The present invention relates to a recording medium apparatus, and particularly relates to a recording medium apparatus having a slidable recording medium holder portion.

Memory cards including semiconductor devices for recording information therein are of wide use as removable recording media because they are small in size, light in weight and easy to handle. Besides, magnetic recording media or micro-hard disk drive type recording media having a magnetic head are also known as recording media.

Recording medium apparatus has a mechanism for loading a recording medium such as a memory card and ejecting the loaded recording medium from the recording medium apparatus, so as to access the loaded recording medium to record information or read information recorded in the recording medium.

Various types of recording medium apparatus are known. For example, one type of recording medium apparatus is designed to insert a recording medium therein simply, and another type of recording medium apparatus is designed to have a holder sliding to a predetermined position where a recording medium should be loaded while holding the recording medium. The latter type of recording medium apparatus is advantageous because it has high reliability in loading a recording medium and it is also smooth in attaching/detaching the recording medium thereto/therefrom.

Such recording medium apparatus having a slidable recording medium holder needs a sliding mechanism, various kinds of positioning mechanisms, and the like. Particularly, it is desired that the recording medium holder is positioned stably when the holder is on standby before a recording medium is inserted therein or after the holder has slid and the recording medium has been moved to a predetermined position where the recording medium should be loaded.

It has been therefore considered to use a so-called reversing spring to stabilize the positioning state. As shown in FIG. 9, a reversing spring 100 includes a winding portion 101 in which a wire is wound, and lock portions 102 and 103 on the opposite ends of the winding portion 101. When the reversing spring 100 is rotated (reversed) around one of the lock portions, the pressing direction of the reversing spring 100 after the reversing varies from that before the reversing.

However, in the reversing spring 100 shown in FIG. 9, a large thickness of the winding portion 101 hinders reduction in thickness of the apparatus.

Also, in the recording medium apparatus in which the recording medium holder can slide, various parts are required for attaining complicated mechanisms such as a sliding mechanism and various positioning mechanism. It is, however, preferable to make the number of parts as small as possible in order to make the recording medium apparatus small in size and simple in configuration.

For example, it is necessary to fix the recording medium holder in a predetermined position till a recording medium is inserted into the recording medium holder. To this end, it is necessary to provide at least three parts including a lock portion for fixing the recording medium holder, as well as a sliding portion and a receiving portion.

### SUMMARY OF THE INVENTION

It is therefore an object of the present invention to provide a recording medium apparatus enable to reduce the thickness of the reversing spring so as to reduce the size and thickness of the recording medium apparatus.

Also, another object of the invention is to provide a recording medium apparatus in which the number of parts can be reduced so that the recording medium apparatus can be made small in size and thickness.

In order to achieve the above object, according to the present invention, there is provided a recording medium apparatus comprising:

a base plate;

a holder, being slidable on the base plate while holding a recording medium inserted in the holder; and

a reversing spring, of which pressing direction changes in accordance with a position of the holder, a first end of the reversing spring being locked on the base plate and a second end of the reversing spring being locked on the holder,

wherein the reversing spring has an arc portion between the first and the second ends, the arc portion extends in a plane surface.

Preferably, the reversing spring has a substantially Ω-shape.

Preferably, the reversing spring presses the holder in a direction to eject a recording medium when the holder is on standby with no recording medium inserted thereto; and

wherein the reversing spring presses the holder in a direction to insert a recording medium when the recording medium is inserted into the holder to reach a position where the recording medium is loaded.

In the above configuration, the reversing spring may be designed to be formed by curving a wire into a plane shape such as a shape of the Greek character Ω so as not to include a winding portion in which a wire is wound. With such a design, the thickness of the reversing spring can be reduced. As a result, the space where the reversing spring is attached is also reduced so that the recoding medium apparatus can be made small in size and thickness.

According to the invention, the thickness of the reversing spring can be reduced so that the recording medium apparatus can be made small in size and thickness.

According to the present invention, there is also provided a recording medium apparatus comprising:

a base plate, formed with a stop portion; and

a holder, being slidable on the base plate while holding a recording medium inserted in the holder;

wherein the stop portion is locked in the holder so as to fix the holder in a predetermined position.

Preferably, the stop portion has a plate-like portion formed by notching the base plate and a protrusion provided on the plate-like portion.

Preferably, the stop portion is released from the lock state due to insertion of the recording medium into the holder so that the holder becomes slidable.

Here, it is preferable that, a forward end portion of the recording medium has an oblique shape.

Here, it is preferable that, the forward end portion has a tapered portion inclined toward the stop portion.

Here, it is preferable that, the protrusion has a tapered portion inclined toward the recording medium.

In the above configurations, It is unnecessary to prepare the stop portion as a separate part, so that the number of parts can be reduced correspondingly.

Accordingly, in the recording medium apparatus, the number of parts for the lock mechanism can be reduced so that the recording medium apparatus can be made small in size and thickness.

### BRIEF DESCRIPTION OF THE DRAWINGS

The above objects and advantages of the present invention will become more apparent by describing in detail preferred exemplary embodiments thereof with reference to the accompanying drawings, wherein:

FIGS. 1A to 1G are schematic views for explaining the fundamental operation of recording medium apparatus;

FIG. 2 is a perspective view showing an example of the specific configuration of the recording medium apparatus;

FIG. 3 is a perspective view showing the state where a recording medium has been inserted into a recording medium holder;

FIG. 4 is a perspective view showing the state where the recording medium has been loaded;

FIG. 5 is a perspective view of the state shown in FIG. 2, viewed from the bottom side of the recording medium apparatus;

FIG. 6 is a perspective view of the state shown in FIG. 4, viewed from the bottom side of the recording medium apparatus;

FIGS. 7A and 7B are plan views showing modifications of a reversing spring;

FIGS. 8A to 8C are schematic views for explaining the operation of a lock mechanism; and

FIG. 9 is a perspective view showing the shape of a related reversing spring.

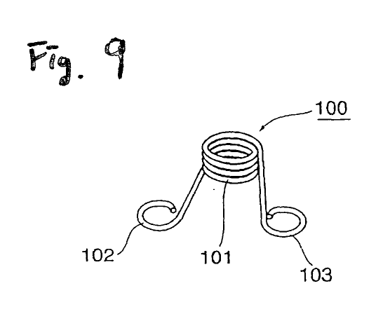

### DETAILED DESCRIPTION OF THE PREFERRED EMBODIMENTS

Recording medium apparatus to which the invention is applied will be described below in detail with reference to the drawings.

Prior to description of the specific configuration of the recording medium apparatus to which the invention is applied, the fundamental operation of the recording medium apparatus will be described first.

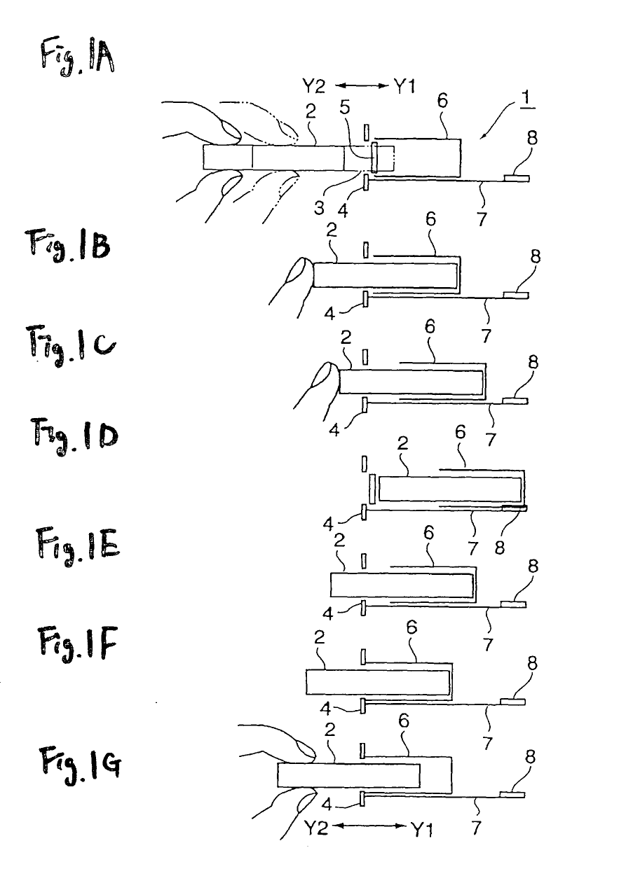

As shown in FIGS. 1A to 1G, recording medium apparatus 1 has a front bezel 4, a cover 5, a housing-like recording medium holder 6 and a base plate 7. The front bezel 4 is formed with a loading slot 3 into which a recording medium 2 such as a memory card should be inserted. The cover 5 closes the loading slot 3. The recording medium holder 6 is supported movably in directions Y1 and Y2 shown in FIGS. 1A to 1G. The recording medium holder 6 holds the recording medium 2 inserted therein. The base plate 7 supports the recording medium holder 6 so that the recording medium holder 6 can slide thereon. A connector portion 8 to be connected to the terminal of the loaded recording medium 2 is provided at a rear end portion of the base plate 7.

The recording medium holder 6 is locked by a not-shown lock mechanism so as not to move in the direction Y1. When the recording medium 2 is inserted into the recording medium holder 6, the recording medium holder 6 is unlocked. When the recording medium 2 is not loaded, or when the recording medium 2 is completely received inside the recording medium holder 6, the cover 5 closes the loading slot 3.

Before the recording medium 2 is loaded, the recording medium holder 6 is positioned as shown in FIG. 1A, and locked by the lock mechanism. When an operator pushes the cover 5 open with a recording medium 2 and inserts the recording medium 2 into the loading slot 3, the recording medium 2 is inserted into the recording medium holder 6 as shown in FIG. 1B. The recording medium holder 6 is unlocked in response to the insertion of the recording medium 2, so that the recording medium holder 6 can move in the arrow Y1 direction.

When the recording medium 2 is further pushed in, the recording medium holder 6 slides to move the recording medium 2 while holding the recording medium 2, as shown in FIG. 1C. Being moved to some extent, the recording medium 2 is retracted in the direction Y1 by the effect of a reversing spring. Thus, the recording medium 2 abuts against the rear end portion of the base plate 7 so as to be fixed thereto in FIG. 1D. On this occasion, the terminal of the recording medium 2 is connected to the connector portion 8 provided in the base plate 7, and the loading slot 3 is closed by the cover 5.

This state is the state where the recording medium 2 is loaded in the recording medium apparatus. In this state, information is written or read between the recording medium 2 and the recording medium apparatus.

To eject the recording medium 2 from the recording medium apparatus after writing or reading of the information, the operator performs an eject operation to push an eject button. In the eject operation, the recording medium holder 6 is released from the fixed state shown in FIG. 1D. Thus, the recording medium holder 6 moves in the arrow Y2 direction so that the cover 5 is pushed open by the recording medium 2 as shown in FIG. 1E. Moving to some extent, the recording medium holder 6 is pushed out in the arrow Y2 direction this time by the effect of the reversing spring. Thus, the recording medium holder 6 moves to a position shown in FIG. 1F. In this state, the operator picks up and takes out the recording medium 2 as shown in FIG. 1G.

The fundamental operation of the recording medium apparatus to which the invention is applied has been described heretofore. Next description will be made on a specific configuration of the recording medium apparatus.

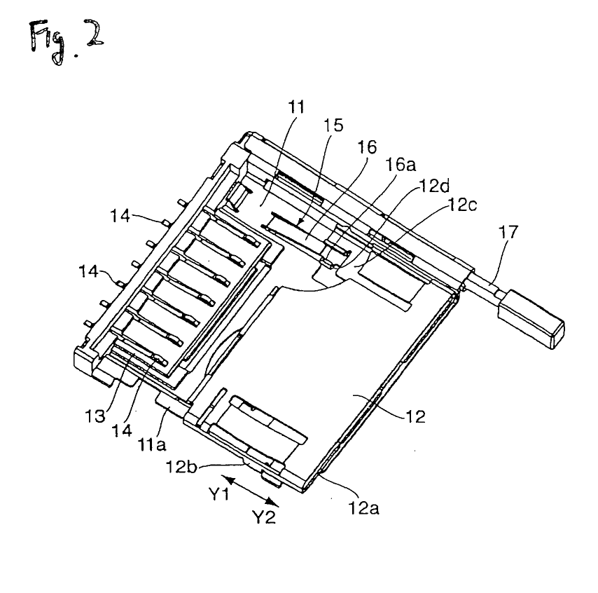

Recording medium apparatus includes a base plate 11 and a recording medium holder 12 slidable on the base plate 11, as shown in FIG. 2. An insulating resin plate 13 is fitted to the rear end portion of the base plate 11, and a plurality of terminal pins 14 are arrayed in the resin plate 13 so as to be formed as a connector portion.

The recording medium holder 12 is a housing-like member made of a metal plate. The recording medium holder 12 has an opening portion 12a into which a recording medium should be inserted. In addition, the recording medium holder 12 has a lock claw 12b. When the lock claw 12b is locked in one side edge 11a of the base plate 11, the recording medium holder 12 can slide on the base plate 11 in the direction Y1 or Y2.

In addition, a lock mechanism 15 for fixing the recording medium holder 12 to the illustrated position is provided in the base plate 11. The lock mechanism 15 is constituted by a stop portion 16 formed by notching the base plate 11. When a protrusion portion 16a of the stop portion 16 is made to abut against one side edge 12d of a bottom plate 12c of the recording medium holder 12, the recording medium holder 12 is fixed.

Further, an eject pin 17 is provided on one side of the base plate 11. The action to eject the recording medium holder 12 is performed by operating the eject pin 17. That is, by the operation of the eject pint 17, a not-shown cam plate locked in the recording medium holder 12 rotates to push out the recording medium holder 12 in the arrow Y2 direction. Incidentally, the eject pint 17 is pulled in the arrow Y1 direction by a spring. Thus, the state shown in FIG. 2 is a stable state of the eject pin 17.

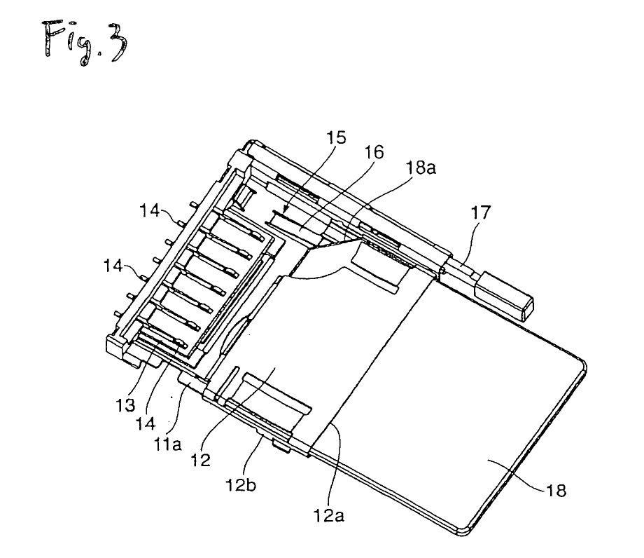

As shown in FIG. 3, when a recording medium 18 is inserted into the recording medium apparatus, the recording medium 18 is inserted into the recording medium holder 12 through the opening portion 12a. This state corresponds to the state of FIG. 1B. When the recording medium 18 is inserted, a front end face 18a cut out obliquely pushes down the protrusion portion 16a of the stop portion 16 so as to release the locking state of the lock mechanism 15. That is, the recording medium holder 12 is made slidable in the arrow Y1 direction.

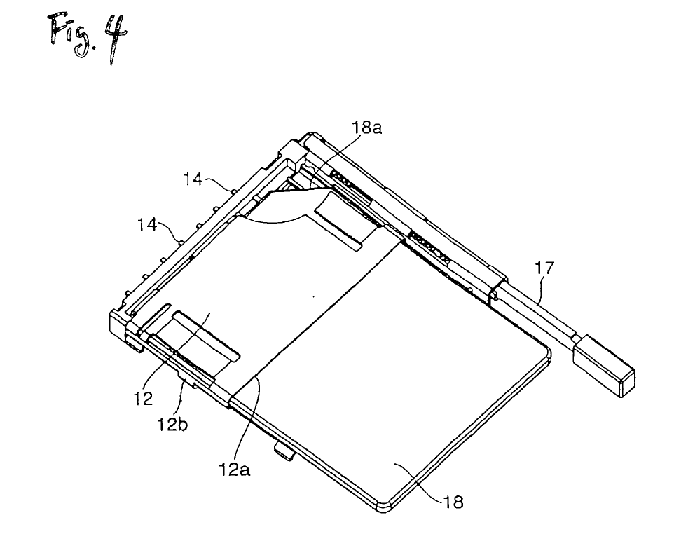

FIG. 4 shows the state where the recording medium 18 is pushed further so that the recording medium holder 12 is made to slide and fixed to the position where the recording medium 18 should be loaded. In this state, the terminal portion of the recording medium 18 is electrically connected to the terminal pins 14 of the connector portion of the base plate 11 so that information can be recorded into the recording medium 18 or information recorded in the recording medium 18 can be read therefrom.

To eject the recording medium 18 after writing or reading of the information, the eject pin 17 is pushed in. As a result, the cam plate rotates to push out the recording medium holder 12 in the arrow Y2 direction.

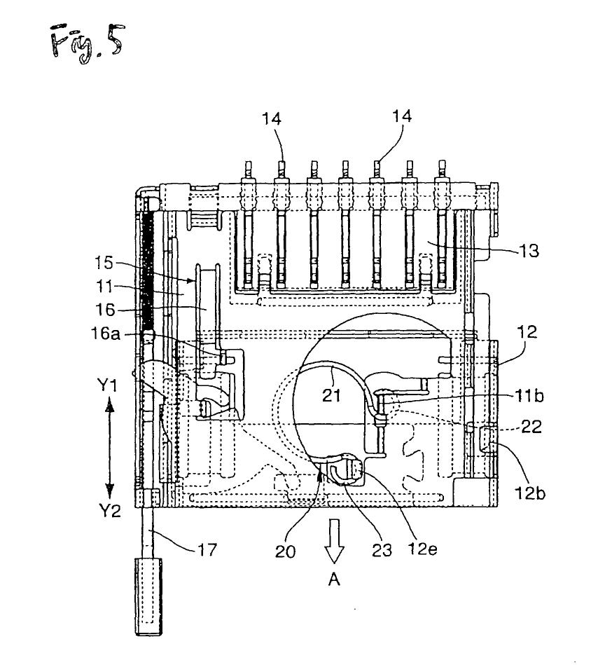

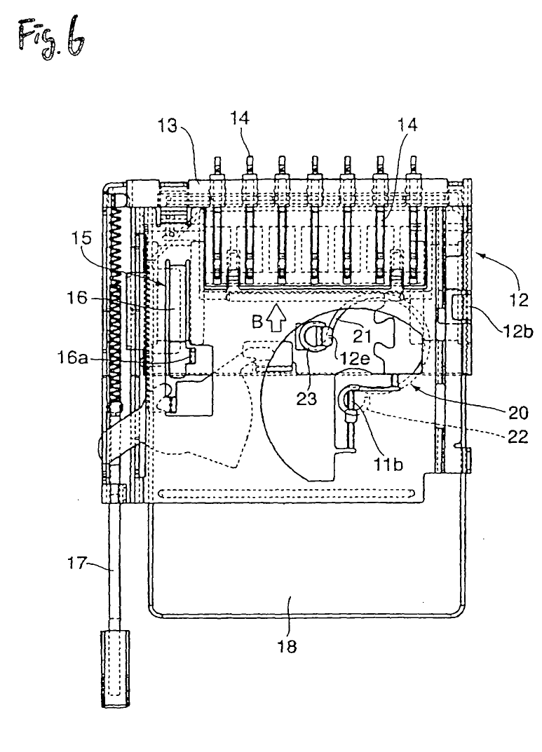

A reversing spring is attached as shown in FIGS. 5 and 6, so as to stabilize the positioning state of the recording medium holder 12. Description will be made below on the reversing spring.

The reversing spring 20 includes an annular spring portion 21 and lock portions 22 and 23 provided on the opposite ends of the spring portion 21 as shown in FIGS. 5 and 6. Thus, the reversing spring 20 is configured without any winding portion in which a wire is wound. One lock portion 22 is fixed to a spring fixation piece 11b provided in the base plate 11 while the other lock portion 23 is fixed to a spring fixation piece 12e provided in the recording medium holder 12.

The base plate 11 is fixed while the recording medium holder 12 is slidable. Thus, the lock portion 22 of the reversing spring 20 fixed to the spring fixation piece 11b of the base plate 11 is fixed while the lock portion 23 can move due to the sliding of the recording medium holder 12. Thus, the reversing spring 20 can rotate around the lock portion 22.

Here, as shown in FIG. 5, when no recording medium is inserted into the recording medium holder 12 (corresponding to the state shown in FIG. 2), the lock portion 23 fixed to the spring fixation piece 12e provided in the recording medium holder 12 is positioned in front of the lock portion 22 fixed to the spring fixation piece 11b of the base plate 11, in the arrow Y2 direction. Therefore, the resilience force of the reversing spring 20 fixed by the spring fixation piece 11b of the base plate 11 is applied in the arrow A direction in the lock portion 23 fixed to the spring fixation piece 12e provided in the recording medium holder 12. That is, the reversing spring 20 presses the recording medium holder 12 toward the loading slot and stabilizes this state of the recording medium holder 12.

On the other hand, as shown in FIG. 6, when the recording medium 18 is loaded (corresponding to the state shown in FIG. 4), the reversing spring 20 reverses its direction due to its rotation, so that the lock portion 23 fixed to the spring fixation piece 12e provided in the recording medium holder 12 is positioned at the rear of the lock portion 22 fixed to the spring fixation piece 11b of the base plate 11, in the arrow Y2 direction. Therefore, the resilience force of the reversing spring 20 fixed by the spring fixation piece 11b of the base plate 11 is applied in the arrow B direction in the lock portion 23 fixed to the spring fixation piece 12e provided in the recording medium holder 12. That is, the reversing spring 20 presses the recording medium holder 12 toward the connector portion and stabilizes the connection state between the recording medium 18 and the connector portion.

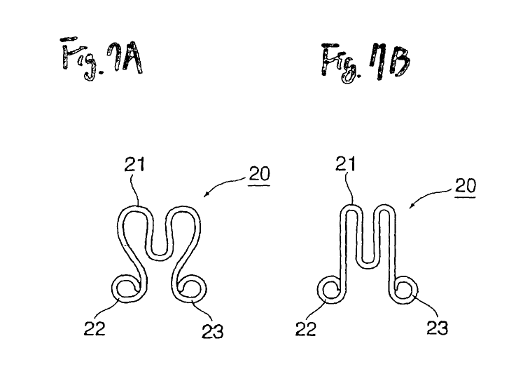

In the above configuration, the reversing spring 20 is formed without any winding portion in which a wire is wound. Therefore, the reversing spring 20 is extremely thin, and the space to receive the reversing spring 20 is also small. Accordingly, the reversing spring 20 is extremely effective in making the recording medium apparatus smaller in thickness. Incidentally, the shape of the reversing spring 20 is not limited to that described in the example, but any other shape may be adopted. FIGS. 7A and 7B show modifications of the reversing spring 20. In any case of the modifications, a function similar to that in the example can be provided.

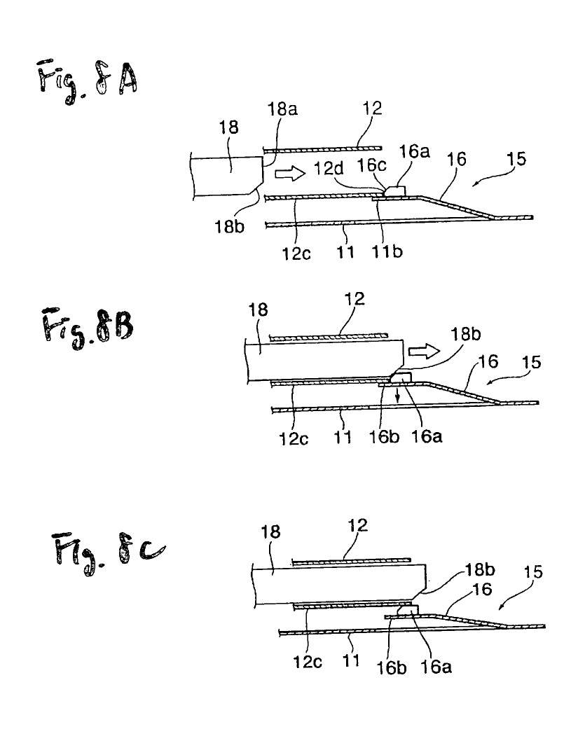

Next, detailed description will be made on the lock mechanism 15. The lock mechanism 15 is configured by forming a protrusion portion 16a in the stop portion 16 cut and raised from the base plate 11, as shown in FIG. 8A. In the state shown in FIG. 2, a plate-like forward end 16b of the stop portion 16 intrudes slightly under a bottom plate 12c of the recording medium holder 12 so as to prevent the stop portion 16 from turning up inadvertently. In addition, the protrusion portion 16a has a slope 16c inclined to the forward end. In the lock mechanism 15, the protrusion portion 16a abuts against one side edge 12d of the bottom plate 12c of the recording medium holder 12 so as to lock the recording medium holder 12.

Here, when the recording medium 18 is inserted as shown in FIG. 8B, the forward end face 18a of the recording medium 18 abuts against the protrusion portion 16a of the stop portion 16. The forward end face 18a of the recording medium 18 is cut out obliquely, and the bottom portion of the forward end face 18a is formed as a tapered face 18b, as shown in FIGS. 5A to 5C.

Thus, when the recording medium 18 is further pushed in, the protrusion portion 16a is pushed down by the tapered face 18b as shown in FIG. 8C. As a result, the locking state of the lock mechanism 15 is released.

Since the lock mechanism 15 has the stop portion 16 cut and raised from the base plate 11, and the recording medium holder 12 sliding on the base plate 11, it is unnecessary to prepare, for example, a lock member. Thus, the number of parts for the lock mechanism 15 can be reduced to two.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A recording medium apparatus comprising:
a base plate;
a holder, being slidable on the base plate while holding a recording medium inserted in the holder; and
a reversing spring, of which pressing direction changes in accordance with a position of the holder, a first end of the reversing spring being locked on the base plate and a second end of the reversing spring being locked on the holder,
wherein the reversing spring has an arc portion between the first and the second ends, the arc portion extends in a plane surface.

2. The recording medium apparatus as set forth in claim 1, wherein the reversing spring has a substantially Ω-shape.

3. The recording medium apparatus as set forth in claim 1, wherein the reversing spring presses the holder in a direction to eject a recording medium when the holder is on standby with no recording medium inserted thereto; and
wherein the reversing spring presses the holder in a direction to insert a recording medium when the recording medium is inserted into the holder to reach a position where the recording medium is loaded.

4. A recording medium apparatus comprising:
a base plate, formed with a stop portion; and
a holder, being slidable on the base plate while holding a recording medium inserted in the holder,
wherein the stop portion is locked in the holder so as to fix the holder in a predetermined position.

5. The recording medium apparatus as set forth in claim 4, wherein the stop portion has a plate-like portion formed by notching the base plate and a protrusion provided on the plate-like portion.

6. The recording medium apparatus as set forth in claim 4, wherein the stop portion is released from the lock state due to insertion of the recording medium into the holder so that the holder becomes slidable.

7. The recording medium apparatus as set forth in claim 6, wherein a forward end portion of the recording medium has an oblique shape.

8. The recording medium apparatus as set forth in claim 7, wherein the forward end portion has a tapered portion inclined toward the stop portion.

9. The recording medium apparatus as set forth in claim 5, wherein the protrusion has a tapered portion inclined toward the recording medium.
